(19) United States
(12) Patent Application Publication
(10) Pub. No.: US 2025/0181702 A1
(43) Pub. Date: Jun. 5, 2025

(54) INFORMATION PROCESSING APPARATUS, INFORMATION PROCESSING METHOD, AND PROGRAM

(71) Applicant: Sony Group Corporation, Tokyo (JP)

(72) Inventors: Atsushi NEGISHI, Tokyo (JP); Takashi OGATA, Tokyo (JP); Ayaka NISHI, Kanagawa (JP)

(73) Assignee: Sony Group Corporation, Tokyo (JP)

(21) Appl. No.: 18/842,053

(22) PCT Filed: Mar. 13, 2023
(86) PCT No.: PCT/JP2023/009611

§ 371 Date: Aug. 28, 2024

(30) Foreign Application Priority Data
Mar. 30, 2022 (JP) 2022-056510

(51) Int. Cl. G06F 21/45

(52) U.S. Cl. CPC G06F 21/45

(57) ABSTRACT

An information processing apparatus includes an evaluation unit that evaluates a plurality of pieces of authentication information regarding a user on a basis of a plurality of evaluation viewpoints and an index for each of the evaluation viewpoints, and a presentation processing unit that performs processing for presenting an evaluation result by the evaluation unit to the user.

### TECHNICAL FIELD

The present technology relates to an information processing apparatus, an information processing method, and a program.

### BACKGROUND ART

In recent years, with the spread of various information devices and Internet services, the importance of security of an information system has increased. User authentication is performed to perform access control by confirming whether or not a user who intends to use an information system actually has authority to use the system.

As one of means for user authentication, there is multi-modal authentication for combining a plurality of pieces of data in which individual differences of users appear to certify identity.

Therefore, a technique has been proposed in which registration information of an audio signal is input, and authentication strength is evaluated by appropriately combining a knowledge element of a password and a biometric element of voiceprint authentication, and a result thereof is notified a user of (Patent Document 1).

### CITATION LIST

### Patent Document

Patent Document 1: Japanese Translation of PCT International Application Publication No. 2017-511915

### SUMMARY OF THE INVENTION

### Problems to be Solved by the Invention

However, the technique of Patent Document 1 basically targets only an audio signal, and has a problem that authentication strength is weak. In addition, although addition of other authentication elements is mentioned, there is also a problem that the authentication strength cannot be increased because the authentication strength including other authentication elements is not evaluated.

The present technology has been made in view of such a problem, and an object thereof is to provide an information processing apparatus, an information processing method, and a program capable of realizing multi-modal authentication with high authentication strength by evaluating authentication information and presenting an evaluation result to a user.

### Solutions to Problems

In order to solve the above-described problem, a first technology is an information processing apparatus includes an evaluation unit that evaluates a plurality of pieces of authentication information regarding a user on a basis of a plurality of viewpoints and an index for each of the viewpoints, and a presentation processing unit that performs processing for presenting an evaluation result by the evaluation unit to the user.

Furthermore, a second technology is an information processing method performing processing for evaluating a plurality of pieces of authentication information regarding a user on a basis of a plurality of viewpoints and an index for each of the viewpoints, and presenting an evaluation result to the user.

Furthermore, a third technology is a program for causing a computer to execute an information processing method performing processing for evaluating a plurality of pieces of authentication information regarding a user on a basis of a plurality of viewpoints and an index for each of the viewpoints, and presenting an evaluation result to the user.

### BRIEF DESCRIPTION OF DRAWINGS

FIG. 1 is a block diagram illustrating a configuration of an electronic device 100.

FIG. 2 is a block diagram illustrating a configuration of an information processing apparatus 200.

FIG. 3 is a flowchart illustrating processing of the information processing apparatus 200.

FIG. 4 is a diagram illustrating a method of presenting an evaluation result of an index “authentication level”.

FIG. 5 is a diagram illustrating a method of presenting an evaluation result of an index “another person's attack resistance”.

FIG. 6 is a diagram illustrating a method of presenting an evaluation result of an index “necessity of modal”.

FIG. 7 is a diagram illustrating a method of presenting an evaluation result of an index “description of use data”.

FIG. 8 is a diagram illustrating a method of presenting an evaluation result of an index “error rate”.

FIG. 9 is a diagram illustrating a method of presenting an evaluation result of an index “stability”.

FIG. 10 is a diagram illustrating a method of presenting an evaluation result of an index “cost”.

FIG. 11 is a diagram illustrating a method of collectively presenting representative numerical values of three evaluation viewpoints.

FIG. 12 is a flowchart illustrating processing in a case where authentication information is used for authentication in various services.

FIG. 13 is a flowchart illustrating processing in a first modification in which a user selects a modal to be used for authentication.

FIG. 14 is a flowchart illustrating processing in a second modification in which the user selects a modal to be used for authentication.

FIG. 15 is a diagram illustrating a UI for the user to select a modal.

FIG. 16 is a block diagram illustrating a modification in which the electronic device 100 is connected to an external server device or another device.

### MODE FOR CARRYING OUT THE INVENTION

Hereinafter, embodiments of the present technology will be described with reference to the drawings. Note that, the description will be given in the following 10 order.
<1. Embodiment>
[1-1. Configuration of electronic device 100]
[1-2. Configuration of information processing apparatus 200]
[1-3. Processing in information processing apparatus 200]
[1-3-1. Overall processing]
[1-3-2. Learning of authentication model]
[1-3-3. Evaluation of authentication information]
[1-3-4. Presentation of evaluation results]
[1-4. Case where registered authentication information is used for authentication in service]
<2. Modifications>
[2-1. Modification in which user selects modal]
[2-2. Other modifications]

### 1. Embodiment

### [1-1. Configuration of Electronic Device 100]

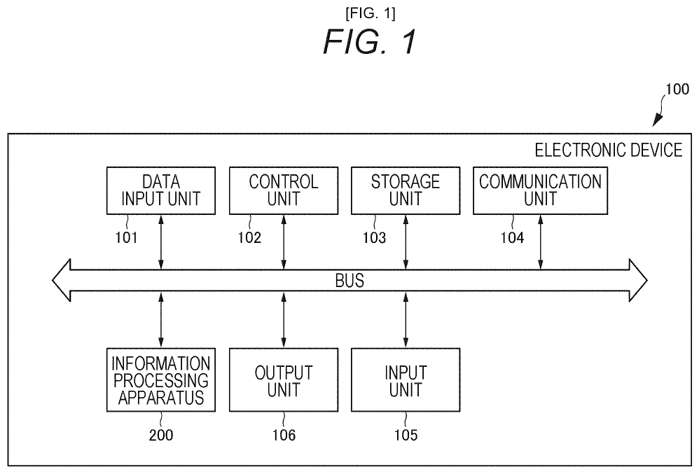

A configuration of an electronic device 100 on which the information processing apparatus 200 according to the present technology operates will be described with reference to FIG. 1. The electronic device 100 includes a data input unit 101, a control unit 102, a storage unit 103, a communication unit 104, an input unit 105, and an output unit 106.

The electronic device 100 and the information processing apparatus 200 are configured to register a plurality of pieces of authentication information to be used for multi-modal authentication for authenticating authenticity by combining a plurality of pieces of input data (authentication information) in which individual differences of users appear. The authentication includes one-to-one authentication for determining whether or not the user to be authenticated is a specific person and one-to-N authentication for determining which person the user to be authenticated is.

The data input unit 101 is configured to input a plurality of input data used as authentication information to the electronic device 100. Specifically, the data input unit 101 is a camera, a microphone, a sensor, an antenna, or the like. However, the data input unit 101 is not limited thereto, and any device may be used as long as input data that can be used for authentication can be input to the electronic device 100.

The authentication information is information used for authentication of the user, and includes input data input from the data input unit 101, feature data obtained by applying predetermined processing to the input data to extract a feature, and the like. The input data is treated as authentication information after being input to the information processing apparatus 200.

Examples of the sensor include an inertial sensor, a distance sensor, a fingerprint sensor, a position sensor, a heart rate sensor, a myoelectric sensor, a body temperature sensor, a perspiration sensor, a brain wave sensor, a pressure sensor, an atmospheric pressure sensor, a geomagnetic sensor, a touch sensor, and so on. However, the sensor is not limited thereto, and any sensor may be used as long as input data that can be used for user authentication can be input to the electronic device 100.

Note that the camera, the microphone, the sensor, and the antenna may be replaced with a dedicated device having their functions as well as an electronic device having their functions, for example, a smartphone, a tablet terminal, a wearable device, or the like.

In the present technology, input data as authentication information is classified into a plurality of types. The type is defined as a modal. Examples of the modal include a position, an action, a motion, a face, a fingerprint/palm print, a voice, social, belongings, a character string, and the like. Therefore, it can be said that any input data as the authentication information belongs to any modal.

Examples of the input data regarding the position include latitude-longitude data of a position where the user exists, position data indicating where the user is outdoors or indoors, and the like. These can be acquired by a position sensor or a distance sensor.

The input data about the action includes a way of walking of the user, a type of moving method of the user (walking, car, train, etc.), the action of the user when using various services, and the like. These can be acquired from an inertial sensor, service use history information, application use time, website browsing history, and the like.

Examples of the input data about motion include data about the speed and direction of the motion of the user's hand when lifting or operating the device. These can be acquired by an inertial sensor.

Examples of the input data for the face include an image of an entire face of the user, an image of a part of the face of the user, and the like. These can be acquired by a camera.

Examples of the input data regarding the fingerprint and palm print include an entire or partial image of the user's palm and an entire or partial image of the user's finger. These can be acquired by a camera or a fingerprint sensor.

Examples of the input data for a voice include a voiceprint, voice data of a voice when a specific word is spoken, voice data of a voice when a daily conversation is performed, an environmental sound, and so on. These can be obtained with a microphone.

Examples of the input data regarding the social nature (real world and the Internet) include a signal emitted by a device owned by another person in the vicinity, a personal relationship in various services on the Internet, and a history of users who have communicated on a social network service (SNS). These can be acquired from use histories in antennas and various services on the Internet.

Examples of the input data regarding the belongings include wireless signals of various devices owned by the user, images of objects owned by the user, and the like. These can be acquired by an antenna or a camera.

Examples of the input data for a character string include a password, an answer to a secret question, and so on. These can be acquired by input from the user.

Note that data other than the above data may be used as input data. The input data may be raw data not subjected to processing, data processed by predetermined processing, data from which a feature amount is extracted, or data including a learned model, statistical information indicating a general tendency, or the like as feature data. Furthermore, the input data may be data subjected to encryption or anonymization processing in consideration of privacy.

It is assumed that a label is given to input data as metadata. In the case of one-to-one authentication, the label represents the user himself/herself who is an authentication target as “1” and the other persons as “−1”. In the case of one-to-N authentication, the label represents a user A as “0”, a user B as “1”, a user C as “2”, and a user D as “3”, . . . . The label may be provided by the electronic device 100 or may be provided by each device as the input unit 105.

A target period of the data as the input data may be arbitrary. In addition, the input data may include data on a plurality of persons. The input data may be authentication information registered in the electronic device 100 in the past, or various types of data already registered for password authentication, fingerprint authentication, face authentication, and the like generally included in a personal computer or the like as the electronic device 100.

In addition, data acquired by another device may be received through the communication unit 104 and used as input data. For example, image data captured by a camera installed in a store is received by a smartphone as the electronic device 100 at hand and used as input data, and so on.

The control unit 102 includes a central processing unit (CPU), a random access memory (RAM), a read only memory (ROM), and the like. The CPU executes various types of processing according to a program stored in the ROM and issues commands, thereby controlling an entire electronic device 100 and each unit thereof.

The storage unit 103 is configured to store input data input from the input unit 105, registered authentication information, and the like. The storage unit 103 is, for example, a mass storage medium such as a hard disk or a flash memory.

The communication unit 104 is a communication interface between the electronic device 100 and an external device, the Internet, or the like. The communication unit 104 may include a wired or wireless communication interface. Furthermore, more specifically, the wired or wireless communication interface may include cellular communication, Wi-Fi, Bluetooth (registered trademark), near field communication (NFC), Ethernet (registered trademark), high-definition multimedia interface (HDMI (registered trademark)), universal serial bus (USB) and the like.

The input unit 105 is used by the user to input an instruction or the like to the electronic device 100. When a user performs an input on the input unit 105, the control signal corresponding to the input is created and supplied to the control unit 102. Then, the control unit 102 performs various types of processing corresponding to the control signal. The input unit 105 includes, in addition to physical buttons, a touch panel, a touch screen integrally constructed with a monitor, and the like.

The information processing apparatus 200 performs evaluation of the authentication information according to the present technology, processing for presenting an evaluation result to the user, and the like. Detailed configuration of the information processing apparatus 200 will be described later.

The output unit 106 is configured to output an evaluation result obtained by the information processing apparatus 200. Examples of the output unit 106 include a display that outputs an evaluation result by display, a speaker that outputs an evaluation result by voice, an actuator that outputs an evaluation result by vibration, and a light emitting diode (LED) that outputs an evaluation result by light. Note that the output unit 106 may be included in a device other than the electronic device 100. For example, the authentication result processed by the smartphone as the electronic device 100 is displayed on a display installed in the store.

The electronic device 100 is configured as described above. Examples of the electronic device 100 include a personal computer, a smartphone, a tablet terminal, a wearable device, eyewear, a television, an automobile, a drone, a robot, and so on.

In a case where there is a program necessary for the processing according to the present technology, the program may be installed in the electronic device 100 in advance, or may be distributed by download, a storage medium, or the like and installed by the user himself/herself.

### [1-2. Configuration of Information Processing Apparatus 200]

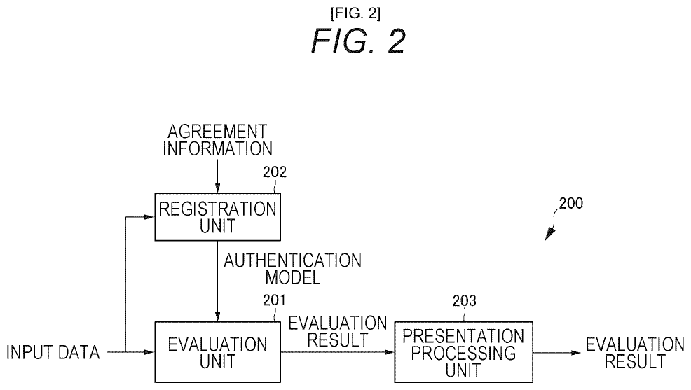

A configuration of the information processing apparatus 200 will be described with reference to FIG. 2. The information processing apparatus 200 includes an evaluation unit 201, a registration unit 202, and a presentation processing unit 203.

The evaluation unit 201 evaluates the authentication information on the basis of one or more of three evaluation viewpoints of security, usability, and privacy. Furthermore, the evaluation unit 201 evaluates the authentication information on the basis of one or a plurality of indexes in the evaluation viewpoint.

The registration unit 202 performs processing of registering authentication information on the basis of agreement regarding registration by the user. Furthermore, the registration unit 202 learns an authentication model for authenticating the user by multi-modal authentication on the basis of the authentication information, and supplies the authentication model to the evaluation unit 201.

The presentation processing unit 203 performs processing of converting the evaluation result of the authentication information into information for a predetermined presentation method in order to present the evaluation result to the user. The evaluation result is presented to the user, so that the user can determine to register the authentication information or input another input data after understanding and agreeing.

The information processing apparatus 200 is configured as described above. In the present embodiment, the information processing apparatus 200 operates in the electronic device 100, but the electronic device 100 may have a function as the information processing apparatus 200 in advance, or the information processing apparatus 200 and the information processing method may be implemented by executing a program in the electronic device 100 having a function as a computer. The program may be installed in the electronic device 100 in advance, or may be distributed by downloading, a storage medium, or the like and installed by a user or the like. Furthermore, the information processing apparatus 200 may be configured as a single apparatus.

### [1-3. Processing by Information Processing Apparatus 200]

### [1-3-1. Overall Processing]

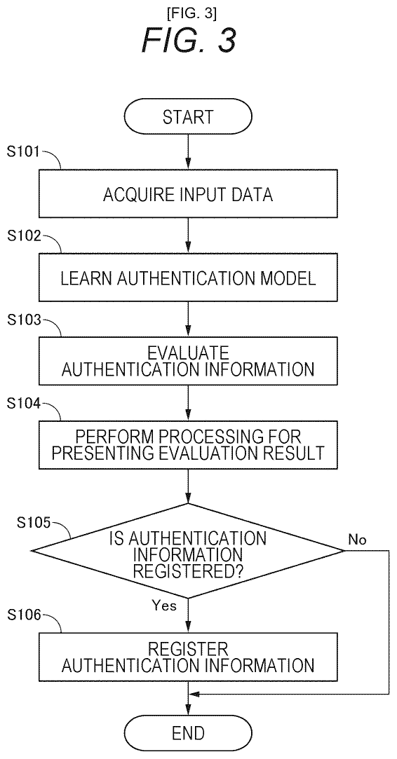

Next, the processing by the information processing apparatus 200 will be described with reference to a flowchart in FIG. 3. Note that details of each step will be described later.

First, in Step S101, the information processing apparatus 200 acquires a plurality of pieces of input data from the input unit 105. As described above, the input unit 105 includes devices such as a camera, a microphone, a sensor, and an antenna. Here, it is assumed that a plurality of pieces of input data belonging to one or a plurality of modals determined in advance by an authentication service provider, a system designer, or the like is acquired from a specific device. Therefore, a plurality of input data belonging to one or a plurality of modals determined in advance may be indicated to the user to prompt the user to input the input data.

Note that the information processing apparatus 200 may directly acquire the input data from the input unit 105, or may temporarily acquire the input data stored in the storage unit 103.

The input data can be acquired by a general method including an instruction to the user by a graphical user interface (GUI). Examples of the input data that can be acquired on the spot by issuing an instruction to the user through the GUI include a password, a fingerprint image, a face image, a motion of a hand of the user when lifting the electronic device 100, a motion of shaking or operating the electronic device 100, and a wireless signal that can be acquired by bringing a device owned by another person close to the electronic device 100 of the user.

The input data is handled as authentication information after acquisition by the information processing apparatus 200.

Next, in Step S102, the registration unit 202 learns the authentication model. The registration unit 202 can use a general machine learning method to classify the user from the authentication information. In the case of one-to-one authentication in which it is determined whether or not the user to be authenticated is a specific user, a two-class classification problem occurs. In addition, in the case of one-to-N authentication for determining which user is to be authenticated, a multi-class classification problem occurs. The authentication model generated by learning can be registered and stored in the storage unit 103. Details of learning of the authentication model will be described later.

Note that, in a case where the input data is data registered in the past as authentication information or data registered in a personal computer or the like as the electronic device 100 (authentication information and the like in general password, fingerprint authentication, face authentication, and the like), the registered authentication information and the input data newly input may be integrated at the time of learning by the registration unit 202. For example, in a case where it takes one week for the electronic device 100 to completely collect necessary input data, the authentication function is used with registered authentication information (for example, a conventional password and a fingerprint) until the collection is completed, and after one week, the authentication information is taken over and main registration is performed, so that the authentication function that extends the conventional authentication function can be used.

Next, in Step S103, the evaluation unit 201 evaluates the authentication information. The evaluation unit 201 evaluates the authentication information from three evaluation viewpoints of security, privacy, and usability. Details of the evaluation of the authentication information will be described later.

Next, in Step S104, the presentation processing unit 203 performs processing for presenting the evaluation result of the authentication information to the user by outputting the evaluation result in the output unit 106. There is a plurality of presentation methods, and the presentation processing unit 203 converts the evaluation result into a form of each presentation method and supplies the converted result to the output unit 106. Then, the output unit 106 outputs the evaluation result converted for presentation, thereby presenting the evaluation result to the user. Note that, in a case where there is an instruction from the user after the registration of the authentication information, only Step S104 may be executed so that the user can reconfirm the authentication information.

Next, in Step S105, the agreement of the user as to whether or not to register the authentication information is confirmed, and in a case where the user agrees, the processing proceeds to Step S106 (Yes in Step S105). Whether or not the user agrees can be determined, for example, by displaying an option of whether or not the user agrees with the display as the output unit 106 and confirming the selection result input by the user through the input unit 105.

Then, in Step S106, the registration unit 202 registers the authentication information on the basis of the agreement of the user who has confirmed the presented evaluation result. The authentication information can be registered, for example, by storing the authentication information in the storage unit 103 in association with the user. Note that the registered authentication information may be stored in the storage unit 103, or the information processing apparatus 200 may include a memory or the like for storing the registered authentication information.

On the other hand, in a case where the user does not agree to the registration of the authentication information in Step S105, the processing ends (No in Step S105). Since the registration of the authentication information is performed on the basis of the agreement of the user, the authentication information is not registered in a case where the user is not satisfied with the evaluation result and does not agree with the registration.

Note that, in order to reduce a calculation time, the learning of the authentication model in Step S102 and the evaluation of the authentication information in Step S103 may be completed in advance with respect to some variations of the input data. In addition, the entire or each step may be reset.

### [1-3-2. Learning of Authentication Model]

Next, learning of the authentication model in Step S102 will be described. The learning of the authentication model can be performed by a general machine learning method such as a k-nearest neighbor algorithm, a decision tree, logistic regression, a support vector machine, or a neural network.

Here, as an example, learning of an authentication model using linear regression in one-to-one authentication will be described. It is assumed that a position and an action are used as a modal.

First, the following three feature amounts are calculated.
Time-related feature amount x1=[Elapsed second from 00:00, integer value in which Monday to Friday correspond to 0 to 6]
Feature amount x2 at position=[latitude and longitude normalized by being discretized in units of 50 km (the surface of the earth is divided by a plurality of grids in units of 50 km), and latitude and longitude normalized in each discretized 50 km region]
Feature amount of action x3=[Average and dispersion of acceleration xyz for 10 seconds and average and dispersion of angular velocity xyz for 10 seconds]

Then, a feature amount obtained by combining x1, x2, and x3 is defined as x.

Furthermore, as illustrated in the following Expression 1, a feature amount matrix obtained by combining feature amounts xg0, xg1, . . . of the user himself/herself and feature amounts xi0, xi1, . . . of another person is set as X.

$$x = [ \begin{matrix}{x}_{1} \\ {x}_{2} \\ {x}_{3}\end{matrix} ] , X = [ {x}_{g 0} , {x}_{g 1} , … , {x}_{i 0} , {x}_{i 1} , … ] \qquad [ Expression 1 ]$$

Furthermore, as shown in the following Expression 2, a label column corresponding to the order of combining the user himself/herself and another person in the feature amount matrix is set as y. In Expression 2, a label corresponding to the feature amount of the user himself/herself is 1, and a label corresponding to the feature amount of another person is −1.

$$y = [ 1 , 1 , … , - 1 , - , … ] \qquad [ Expression 2 ]$$

As shown in the following Expression 3, a weight w is learned by minimizing the right expression so as to approach y=wTX. In the present technology, the authentication model corresponds to the weight w in Expression 3.

$${min}_{w} d ( {w}^{T} X , y ) * d ( a , b ) : distance function between a and b \qquad [ Expression 3 ]$$

Note that, when authentication is actually performed, the feature amount x′ is first calculated, and it can be determined as the user himself/herself when wTx′≥0, and as another person when wTx′<0 by using the weight w. In addition, a general method may be applied to a distance function d and the minimization.

Note that, in learning of the authentication model, in order to improve recognition performance and robustness, input data may be processed by, for example, data augmentation or the like to increase data. In addition, a uniform rule may be applied regardless of the user, instead of being personalized to the user by machine learning. In addition, in a case where a certain hyperparameter method is used, the hyperparameter may be adjusted according to the input data. Furthermore, instead of a late fusion that is combined and learned after the feature amount extraction as described above, early fusion that combines and learns the input data as it is may be used. In addition, a plurality of different authentication models may be learned, and the authentication model may be switched according to a situation when the user uses the authentication service. In addition, relearning of an authentication model learned in advance, such as transfer learning, may be performed. Furthermore, in the case of a method in which a score or a probability is output, a determination threshold may be set in order to adjust a false rejection rate (FRR) or a false acceptance rate (FAR).

### [1-3-3. Evaluation of Authentication Information]

Next, the evaluation of the authentication information by the evaluation unit 201 in Step S103 will be described. The evaluation unit 201 evaluates the authentication information from three evaluation viewpoints of security, privacy, and usability. Further, the evaluation unit 201 evaluates the authentication information with a plurality of indexes for each of the evaluation viewpoints.

First, for security, authentication information is evaluated by an index of “authentication level” and “resistance to another person's attack”.

The authentication level is an index indicating that the authentication strength is weaker as the value of “1−FAR” is closer to 0 and the authentication strength is stronger as the value is closer to 1 using a false acceptance rate (FAR) indicating an error rate at which another person is recognized as a user to be authenticated.

The resistance to another person's attack is an index indicating resistance to presentation attack by a malicious person. Regarding another person's attack resistance, a value between 0 and 1 representing resistance to presentation attack is estimated for each modal and the values on the modal are summed with a maximum value of 1, a value closer to 0 indicates that there is a risk of another person's attack, and a value closer to 1 indicates that it is safer. The index may be calculated from data accepted by others, data accepted by others, data obtained by processing personal data, and the like. The “data accepted by another person” is a set of data determined to be the user himself/herself when the feature amount to which the other person label is assigned at the time of learning is determined and a set of data not used for learning determined to be the person himself/herself when the other person label is assigned for evaluation of the FAR index and the feature amount is determined.

Here, a method of calculating another person's attack resistance will be described as a specific example.

First, a tolerance for the modal “position” can be calculated as follows. FAR′ is calculated using xi′ (represented by Expression 5) in which a position modal x2i of a feature amount xi (represented by Expression 4) of another person is replaced with a position modal x2g of the user himself/herself.

$${x}_{i} = [ \begin{matrix}{x}_{1 i} \\ {x}_{2 i} \\ {x}_{3 i}\end{matrix} ] \qquad [ Expression 4 ]$$

$${x}_{i}^{′} = [ \begin{matrix}{x}_{1 i} \\ {x}_{2 g} \\ {x}_{3 i}\end{matrix} ] \qquad [ Expression 5 ]$$

xi′ expressed in Expression 5 is a feature amount when the position-modal pattern is imitated by a malicious person like the user himself/herself.

For example, although FAR=0.1 was originally set in xi, FAR′=0.6 is set in xi′, and an error rate of another person's acceptance increases.

The tolerance for the action modal can be calculated as follows. The FAR″ is calculated using xi″ (represented by Expression 6) in which an action modal x3i of the feature amount xi (represented by Expression 5) of another person is replaced with an action modal x3g of the user himself/herself.

$${x}_{i}^{″} = [ \begin{matrix}{x}_{1 i} \\ {x}_{2 i} \\ {x}_{3 g}\end{matrix} ] \qquad [ Expression 6 ]$$

xi″ expressed in Expression 7 is a feature amount when the action modal pattern is imitated by a malicious person like the user himself/herself.

For example, although FAR=0.1 was originally set in xi, FAR″=0.8 is set in xi″, and an error rate of another person's acceptance increases.

Then, another person's attack resistance is calculated by the following Expression 8. As another person's attack resistance is closer to 0, there is a risk of another person's attack, and as another person's attack resistance is closer to 1, it is safe.

Another person's attack resistance=(1−FAR′)+(1−FAR″) [Expression 8]

For example, in a case where the FAR′ of the position modal is 0.6 and the FAR″ of the action modal is 0.8, another person's attack resistance is 0.6 on the basis of Expression 8. Note that another person's attack resistance may be calculated not by the sum of a plurality of modals but by an average.

In addition, for privacy, authentication information is evaluated by an index of “necessity of modal” and “description of input data to be used”.

The necessity of the modal is an index indicating that a method of general machine learning capable of describing the importance of the modal is applied, normalization is performed, and the closer to 0, the less necessary the acquisition is, and the closer to 1, the more necessary the acquisition is. For example, there are importance in a decision tree, a sharp ray value in a neural network, and the like.

The description of the input data to be used indicates how to use the input data by converting a feature amount obtained by processing the input data into a format that can be easily understood by the user.

Further, for usability, the authentication information is evaluated by indices of “error rate”, “stability”, and “cost”.

The error rate is an index indicating that the closer to 0, the smaller the number of errors, and the closer to 1, the larger the number of errors, using an error rate FRR (False Rejection Rate) that recognizes the user to be authenticated as another person.

The stability is obtained by calculating and normalizing a general index representing the stability and complexity of the authentication model, and is an index indicating that the closer to 0, the more difficult the user can understand the authentication result, and the closer to 1, the easier the user can grasp the authentication result. Note that conditions of available time zones and places may be extracted.

The cost is an index indicating that a value between 0 and 1 representing a battery consumption amount, a storage consumption amount, and a communication amount is estimated, and as the value itself or the average value thereof is closer to 0, a cost burden is smaller, and as the value is closer to 1, the cost burden is larger.

For example, in a case where the battery consumption amount is 0.6, the storage consumption amount is 0.4, and the communication amount is 0.3, the average value thereof can be calculated as “(0.6+0.4+0.3)/3=0.43”.

Note that the index and the calculation method thereof are not limited to those described above, and other indexes and other calculation methods may be used.

The evaluation unit 201 may individually evaluate a plurality of pieces of authentication information used for multi-modal authentication, or may evaluate a plurality of pieces of authentication information in combination.

The evaluation unit 201 evaluates the authentication information by all the indexes in each of security, privacy, and usability by default, but there is always no necessary to evaluate the authentication information by all the evaluation viewpoints and all the indexes, and the authentication information may be evaluated by any one or a plurality of evaluation viewpoints and any one or a plurality of indexes. Furthermore, which evaluation viewpoint and index the evaluation unit 201 evaluates may be determined in advance by an authentication service provider, a system designer, or the like, and set in the information processing apparatus 200. In addition, the evaluation viewpoint and the index may be determined in advance according to the type of input data. Further, the user may determine which evaluation viewpoint and index are used for evaluation.

In addition, which index is finally evaluated may be automatically selected on the basis of the value of each index. For example, a priority and a threshold may be set for the value of the index, and the value of the index may be selected in a case where the value of the index exceeds or falls below a certain threshold.

For example, the threshold corresponding to a priority 1 of the index “authentication level” is set to 0.8, and the threshold corresponding to a priority 2 is set to 0.5. In addition, a threshold corresponding to the priority 1 of the index “another person's attack resistance” is set to 0.6, and a threshold corresponding to the priority 2 is set to 0.3. Then, in a case where the value of the index “authentication level” calculated by the evaluation unit 201 is 0.9 and the value of “another person's attack resistance” is 0.5, the value of “authentication level” exceeds the threshold of the priority 1, and the value of “another person's attack resistance” does not exceed the threshold of the priority 1. Therefore, “authentication level” exceeding the threshold of the priority 1 is selected as an index to be evaluated.

In addition, in a case where the priority and the threshold are set to be the same, and in a case where the value of the index “authentication level” calculated by the evaluation unit 201 is 0.7 and the value of “another person's attack resistance” is 0.6, since the value of “authentication level” does not exceed the threshold of the priority 1 and the value of “another person's attack resistance” exceeds the threshold of the priority 1, “another person's attack resistance” exceeding the threshold of the priority 1 is selected as an index for evaluating.

Note that the maximum number of indexes to be selected in a case where the number of indexes whose values exceed the threshold is large may be determined in advance by an authentication service provider, a system designer, or the like. In addition, the priority and the threshold may be determined in advance by an authentication service provider or a system designer.

### [1-3-4. Presentation of Evaluation Results]

Next, processing by the presentation processing unit 203 in Step S104 and presentation of an evaluation result to the user will be described. There is a plurality of presentation methods, and the presentation processing unit 203 converts the evaluation result into a form of each presentation method and supplies the converted result to the output unit 106. Then, the output unit 106 outputs the evaluation result converted for presentation, thereby presenting the evaluation result to the user.

In a case where the evaluation unit 201 individually evaluates a plurality of pieces of authentication information used for multi-modal authentication, the presented evaluation result is an evaluation result for specific individual authentication information. Furthermore, in a case where the evaluation unit 201 evaluates a plurality of pieces of authentication information in combination, the evaluation result to be presented is an evaluation result for a state in which a plurality of pieces of authentication information is combined.

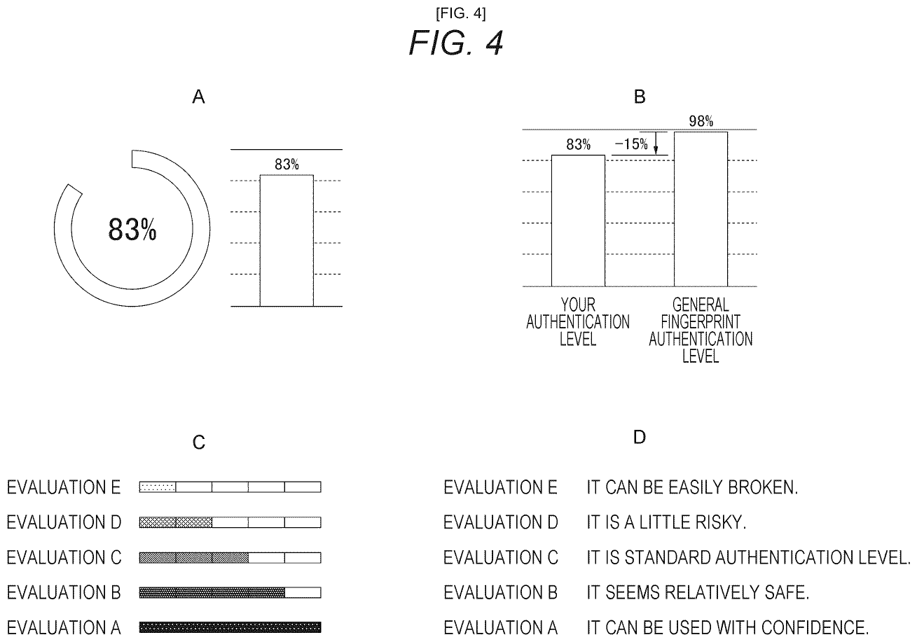

As a method of presenting the evaluation result of the index “authentication level” of the evaluation viewpoint “security”, there is a method of presenting a numerical value (%) as illustrated in FIG. 4A. The presentation processing unit 203 can present the evaluation result as a numerical value (%) by calculating a ratio of the evaluation result output as the numerical value (value between 0 and 1) from the evaluation unit 201 with the maximum value of the numerical value as 100%.

In addition, at the time of presentation by the ratio (%), a result of comparison with a representative value in another authentication method may be simultaneously presented as illustrated in FIG. 4B.

In addition, as a method of presenting the evaluation result of the index “authentication level”, there is a presentation method by stages as illustrated in FIG. 4C. The presentation processing unit 203 compares the evaluation result output as a numerical value (value between 0 and 1) from the evaluation unit 201 with a threshold corresponding to each of a plurality of stages (for example, five stages of evaluation A to evaluation E), so that the evaluation result that is a numerical value can be converted into stages and presented.

Furthermore, as a method of presenting the evaluation result of the index “authentication level”, there is a presentation method using a sentence as illustrated in FIG. 4D. The presentation processing unit 203 compares the evaluation result output as a numerical value (value between 0 and 1) from the evaluation unit 201 with a threshold corresponding to each of a plurality of stages (for example, 5 stages) in which a sentence is associated, so that the evaluation result that is a numerical value can be converted into a sentence and presented.

As a method of presenting the evaluation result of the index “another person's attack resistance” of the evaluation viewpoint “security”, there are presentation by numerical values illustrated in FIGS. 4A and 4B similar to the index “authentication level” and presentation by the stage illustrated in FIG. 4C.

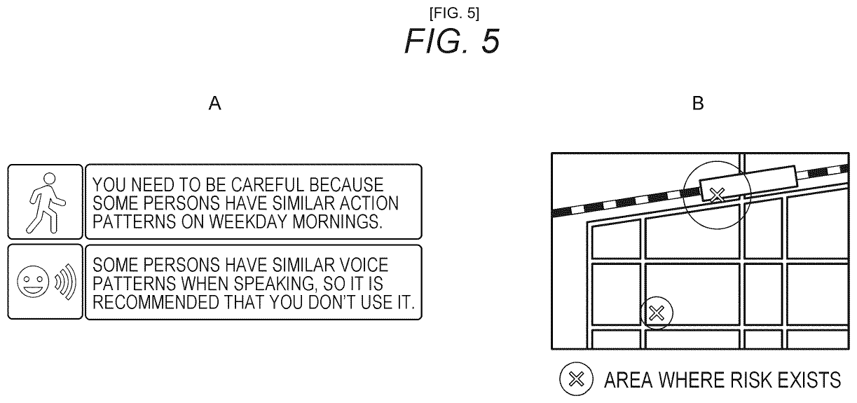

Furthermore, as a method of presenting the evaluation result of the index “another person's attack resistance”, there is presentation by description of a weak pattern of sentences as illustrated in FIG. 5A. The presentation processing unit 203 compares the evaluation result indicating the resistance output as a numerical value (value between 0 and 1) from the evaluation unit 201 with a threshold corresponding to each of a plurality of stages (for example, 5 stages) in which a sentence is associated, so that the evaluation result that is a numerical value can be converted into a sentence and presented.

Furthermore, as a method of presenting the evaluation result of the index “another person's attack resistance”, there is presentation by visualizing a weak pattern as illustrated in FIG. 5B.

In both the description of the weak pattern sentence and the visualization of the weak pattern, when the evaluation result indicating the tolerance output as a numerical value from the evaluation unit 201 falls below a certain threshold, the presentation content can be determined by associating the evaluation result with a specific sentence or figure. Furthermore, the presentation content can be determined by dividing a time axis by several time scale units (for example, in units of one hour, morning, daytime, and evening, the day of the week, weekdays and holidays, and when talking, and the like) to calculate the evaluation result or calculating the evaluation result under a specific temporal condition (for example, at the time of commuting, at the time of traveling, or the like), and associating the evaluation result with a specific sentence or figure when the evaluation result falls below a threshold. Similarly, like an “area”, an evaluation result is calculated by being divided by several spatial scale units (for example, in units of 100 m, in units of 50 km, and the like) as spatial axes, or an evaluation result is calculated under a condition of a specific space (for example, a home, a workplace, a store, a convenience store, or the like). When the evaluation result falls below a threshold, the presentation content can be determined by associating the evaluation result with a specific sentence or figure.

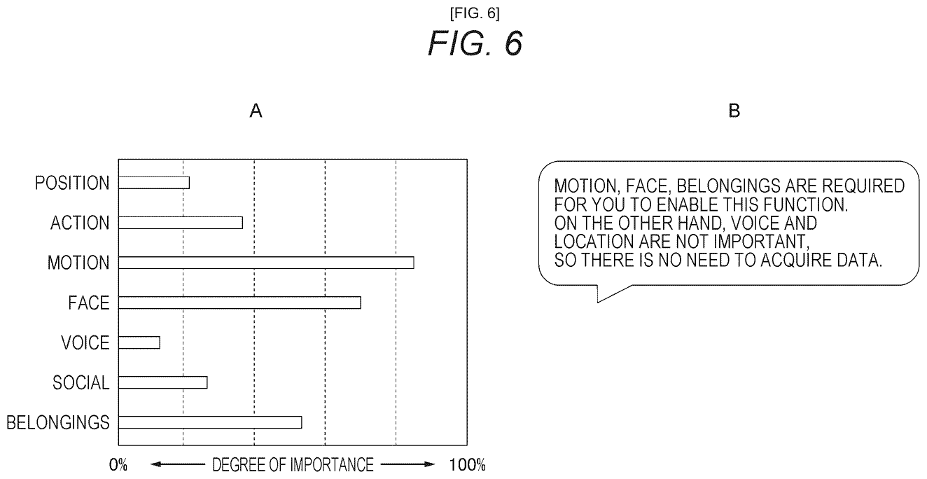

As a method of presenting the evaluation result of the index “necessity of modal” of the evaluation viewpoint “privacy”, there is a presentation method by a graph as illustrated in FIG. 6A. The presentation processing unit 203 can present the evaluation result as a graph by graphing the evaluation result output as a numerical value (value between 0 and 1) for each modal, with 0 as the minimum value of the graph and 1 as the maximum value of the graph.

At the time of presentation by a graph, description by sentence may be added as illustrated in FIG. 6B. This presentation of the sentence can be realized by associating the sentence of the template with each modal in advance and presenting the sentence of the template for a modal with high necessity (for example, equal to or more than a threshold).

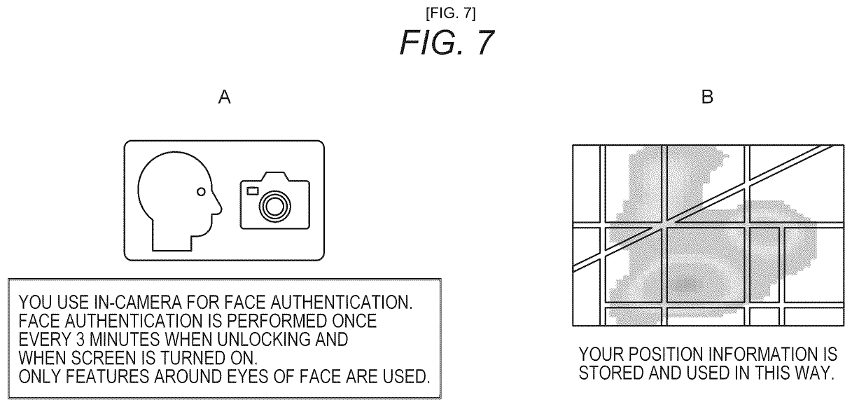

In addition, in the index “description of input data to be used” of the evaluation viewpoint “privacy”, there is a presentation method using a sentence illustrated in FIG. 7A. The evaluation result can be presented as a sentence by associating a plurality of sentences with a plurality of values of different feature amounts in advance and specifying which sentence corresponds to the feature amount obtained by processing the input data. Furthermore, as illustrated in FIG. 7B, how to use the input data related to the position can also be presented in the form of a map. The presentation content can be determined by associating the feature amount from the viewpoint of raising privacy concerns with sentences and drawings in each modal.

As a method of presenting the evaluation result of the index “error rate” of the evaluation viewpoint “usability”, there are presentation by numerical values illustrated in FIGS. 4A and 4B and presentation by stages illustrated in FIG. 4C similar to the index “authentication level”.

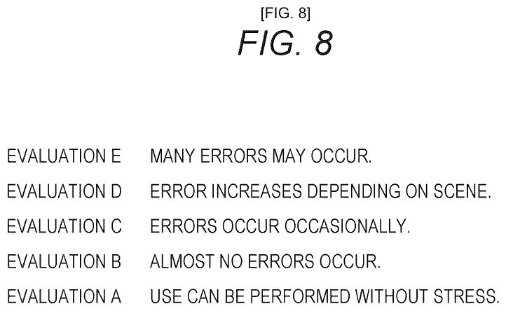

Furthermore, as a method of presenting the evaluation result of the index “error rate”, there is a presentation method using a sentence as illustrated in FIG. 8. The association between the evaluation result and the sentence by the presentation processing unit 203 is similar to that in the description of FIG. 4D, and in FIG. 8, a sentence indicating the evaluation on the error rate is presented.

As a method of presenting the evaluation result of the index “stability” of the evaluation viewpoint “usability”, there are presentation by the numerical values illustrated in FIGS. 4A and 4B and presentation by a stage illustrated in FIG. 4C similar to the index “authentication level”.

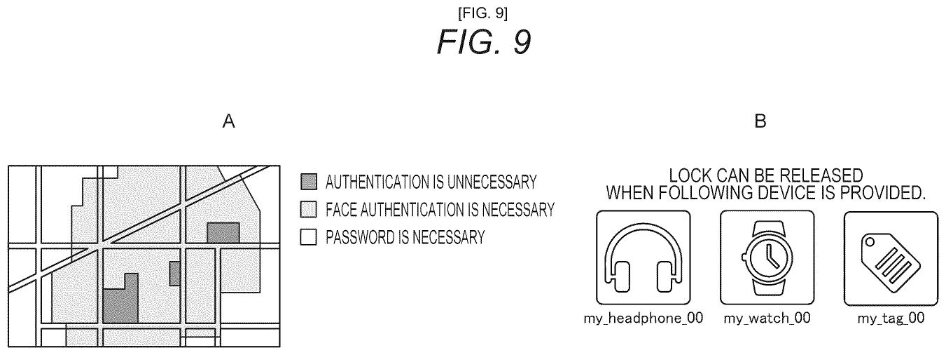

In addition, in the index “stability”, as illustrated in FIGS. 9A and 9B, a condition for using the authentication function can also be presented.

As a method of presenting the evaluation result of the index “cost” of the evaluation viewpoint “usability”, there are presentation by the numerical values illustrated in FIGS. 4A and 4B and presentation by a stage illustrated in FIG. 4C similar to the index “authentication level”.

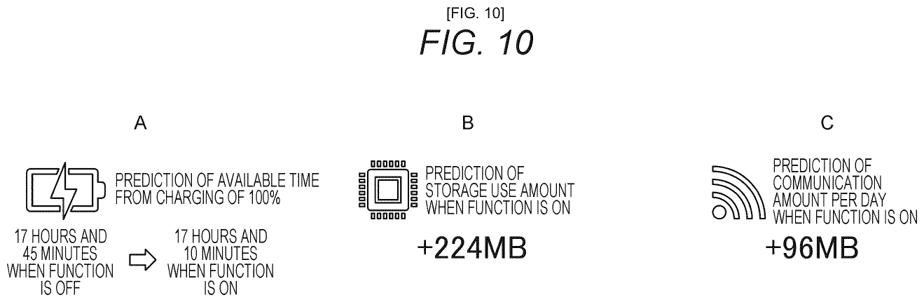

Furthermore, as a method of presenting the evaluation result of the index “cost”, the consumption of the battery (prediction result of the available time of the electronic device 100) can be presented as illustrated in FIG. 10A. In a case where the value between 0 and 1 representing the battery consumption amount represents a ratio of the battery consumption amount per unit time, the battery consumption amount in a case where the authentication function is turned on is calculated from the value, and a battery remaining amount, that is, the remaining operable time of the electronic device 100 can be further grasped from the battery consumption amount, and can be presented.

Furthermore, as a method of presenting the evaluation result of the index “cost”, it is also possible to present a storage consumption amount of the storage unit 103 when the function and the authentication function of the information processing apparatus 200 are turned on as illustrated in FIG. 10B. In a case where the value between 0 and 1 representing the storage consumption amount represents the ratio of the storage unit 103 to the entire storage, the storage consumption amount when the authentication function is turned on can be calculated and presented from the value.

Furthermore, as a method of presenting the evaluation result of the index “cost”, it is also possible to present the function of the information processing apparatus 200 and the communication amount when the authentication function is turned on as illustrated in FIG. 10C. In a case where the value between 0 and 1 representing the communication amount represents the ratio of the communication amount per unit time, the communication amount per day in a case where the authentication function is turned on can be calculated and presented from the value.

Each of the battery consumption amount, the storage consumption amount, and the communication amount when the authentication function is on and off is actually measured per unit time, a difference therebetween is calculated, and normalization is performed with a predetermined upper limit value (for example, a value that is generally considered to be large in amount, and a value calculated in accordance with specifications of a terminal capacity), whereby an evaluation result of the value between 0 and 1 can be obtained. In the presentation method illustrated in FIGS. 10A, 10B, and 10C, the battery consumption amount and the increase/decrease amount of the storage consumption amount per unit time (for example, one hour, one day, etc.) can be presented as specific values, or the battery consumption amount can be presented by estimating the available time of the battery.

When the evaluation result is presented, a name of the input data to be evaluated and a name of the modal to which the input data belongs may be simultaneously presented.

In the presentation of the evaluation results on the display as the output unit 106, the evaluation results in all the evaluation viewpoints and indexes may be presented by switching the evaluation viewpoints and indexes with tabs or the like.

Although it has been described that the presentation processing unit 203 converts the evaluation result of the authentication information into information to be presented, the conversion processing may be performed by the evaluation unit 201.

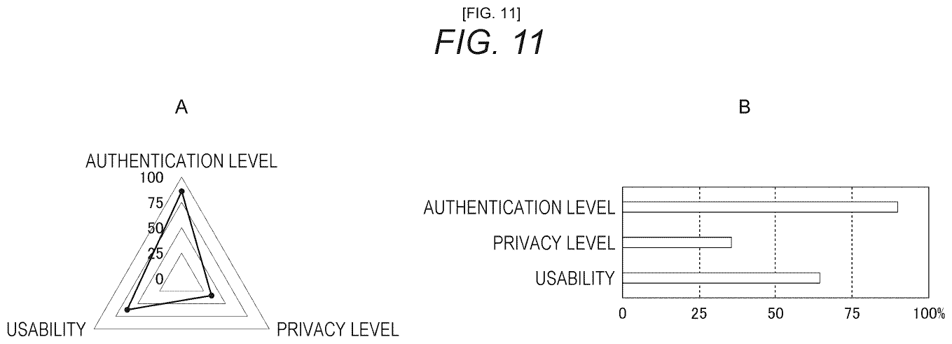

In addition, as illustrated in FIGS. 11A and 11B, representative numerical values of the three evaluation viewpoints may be collectively presented. In FIGS. 11A and 11B, an “authentication level” indicates an evaluation viewpoint “security”, a “privacy level” indicates an evaluation viewpoint “privacy”, and “usability” indicates an evaluation viewpoint “usability”. Note that any one of the indices may be selected in each evaluation viewpoint, or an index obtained by integrating each of the indices may be newly calculated. For example, the index of “usability” is set to only “error rate”, and the index of “usability” is set to an average of “error rate”, “stability”, and “cost”.

Note that the method of presenting the evaluation result is not limited to the display on the display, and the evaluation result may be output as a voice from a speaker, or presentation at the stage of the evaluation result may be performed by the number of times of lighting of the LED or the like.

The processing by the information processing apparatus 200 is performed as described above. According to the present technology, authentication information is evaluated and an evaluation result is presented to a user, so that multi-modal authentication having high authentication strength and enabling safe and secure use can be realized. Since the evaluation viewpoints include security, privacy, and usability, and each evaluation viewpoint has an evaluation index, the user can grasp the evaluation of each evaluation viewpoint and the details thereof.

Furthermore, since the input data used for the multi-modal authentication can be arbitrarily combined, the accessibility of the user can be improved. For example, even a user who cannot use or is difficult to use an existing authentication function using a face, a fingerprint, or the like can register authentication information and use the authentication function.

In addition, since the input data used for the multi-modal authentication can be arbitrarily combined, the authentication strength can be increased, and the usability of the user can be improved. For example, the authentication function can be used according to a situation of an unavailable modal and an available modal, such as when the face is out of the angle of view of the camera or when the face is underground and position information cannot be acquired.

In addition, since the input data used for the multi-modal authentication can be arbitrarily combined, the number of options of the modal to be used increases, and the user can freely customize.

[1-4. Case where Registered Authentication Information is Used for Authentication in Service]

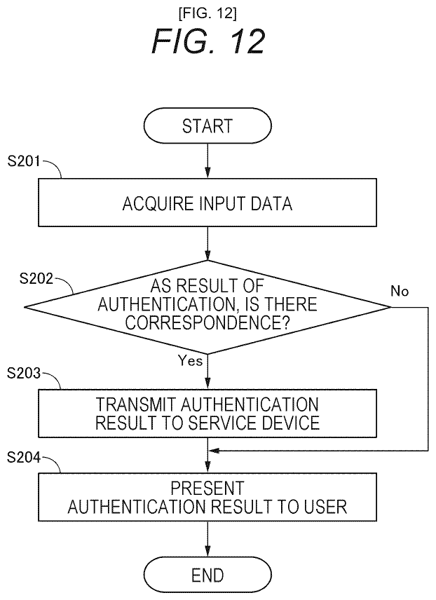

Next, a case where the authentication model learned by the information processing apparatus 200 and the authentication information registered by the information processing apparatus 200 are used for authentication required in various services will be described with reference to FIG. 12. This processing is executed when authentication is requested in various services. The authentication executed here is multi-modal authentication using a plurality of authentication information.

A device that performs authentication using the authentication model learned by the information processing apparatus 200 and the authentication information registered by the information processing apparatus 200 is referred to as an authentication device. Examples of the authentication device include a personal computer, a smartphone, a tablet terminal, a dedicated authentication device, and so on. It is assumed that the authentication device holds in advance the authentication model learned by the information processing apparatus 200 and the authentication information registered by the information processing apparatus 200. Note that the electronic device 100 on which the information processing apparatus 200 operates may function as an authentication apparatus. In addition, a device that performs processing for providing a service is referred to as a service device. Examples of the service device include a personal computer, a smartphone, a tablet terminal, a dedicated device, and the like.

Examples of the various services include various web sites that require authentication at the time of login, online payment services, security services that provide a lock system, and the like.

First, in Step S201, the authentication device acquires a plurality of input data. In the acquisition of the input data, raw input data input from a camera, a microphone, a sensor, or the like may be acquired, or characteristic amount data obtained by processing the input data may be acquired from a storage medium or the like.

Note that, in a case where the data necessary for the authentication is insufficient, the user may be prompted to input the data on the spot to acquire the data. For example, there are a designated user ID in one-to-one authentication, a touch on a fingerprint sensor, a shake of a device, an NFC touch of a specific belongings, or the like.

Next, in Step S202, the user is authenticated using the input data as the authentication information and the learned authentication model. In the case of one-to-one authentication, it is determined whether or not the user corresponds to a specific person, and in the case of one-to-N authentication, it is determined which person the user corresponds to.

In a case where the result of the authentication is successful, that is, the user corresponds to a specific person (one-to-one authentication) or the user corresponds to a specific person (one-to-N authentication), the processing proceeds to Step S203 (Yes in Step S202). Then, in Step S203, the authentication device transmits an authentication result to the service device through the network. For this transmission of the authentication result, for example, a general method is used in which information of the authentication result is verified in a service device by adding a predetermined signature.

Next, in Step S204, the authentication result is presented to the user by display on the display or the like. In a case where the user corresponds to a specific person by one-to-one authentication, it is presented to the user that the authentication has succeeded. Furthermore, information related to the person corresponding to the user is presented by one-to-N authentication.

On the other hand, in a case where the result of the authentication is an authentication failure (error) in Step S202 (No in Step S202), the processing proceeds to Step S204, and a fact that the authentication has failed is presented to the user. Then, the processing ends.

Note that an authentication state may be continued by performing a series of processing frequently or periodically while using the service.

Note that, in an unexpected situation such as a case where the input data is insufficient or the acquired input data is invalid data, it may be determined as an error. In addition, in a case where it is determined that there is an error a predetermined number of times or more within a certain period, it may be determined that the authentication has failed.

In a case where a plurality of authentication models is registered, an appropriate authentication model may be selected according to a situation at the time of authentication. For example, instead of the authentication model in which the input data of the modal necessary for authentication is insufficient, the authentication model in which the input data of the modal necessary for authentication can already be acquired may be selected. Furthermore, for example, in a case where the position of the user is away from a normal range of action by a predetermined distance on the basis of the position information, the authentication model learned on the fingerprint modal may be selected. Furthermore, a model that satisfies the authentication level required for each service may be selected.

In a case where it is determined in Step S202 that “there is applicable”, the authentication model may be updated using the input data up to that time.

The device that outputs the authentication result may be another device other than the authentication device. For example, the authentication device is a smartphone, and a result of authentication by the smartphone is displayed on a display of a cash register of a store, and the like.

In addition, how much the authentication result is presented to the user may be arbitrary. For example, the authentication result is presented only with an icon indicating that the key is released or is not released, or only that the authentication is performed is presented, and the like.

In addition, a reason why such an authentication result has been obtained may be presented to the user. For example, it may be presented that the authentication is successful since what conditions are satisfied, such as “because I am at home”, “because I wear my_headphone_00”, and “because I run daily”. Furthermore, for example, it is also possible to present what type of modal is used for authentication, such as “use of face authentication with camera”, “use of position information”, and “use of voice”. Note that it is not necessary to present why such an authentication result has been obtained. By not presenting anything, the user can use the service without being conscious of authentication.

### <2. Modifications>

[2-1. Modification in which User Selects Modal]

Although the embodiment of the present technology has been specifically described above, the present technology is not limited to the above-described embodiment, and various modifications based on the technical idea of the present technology are possible.

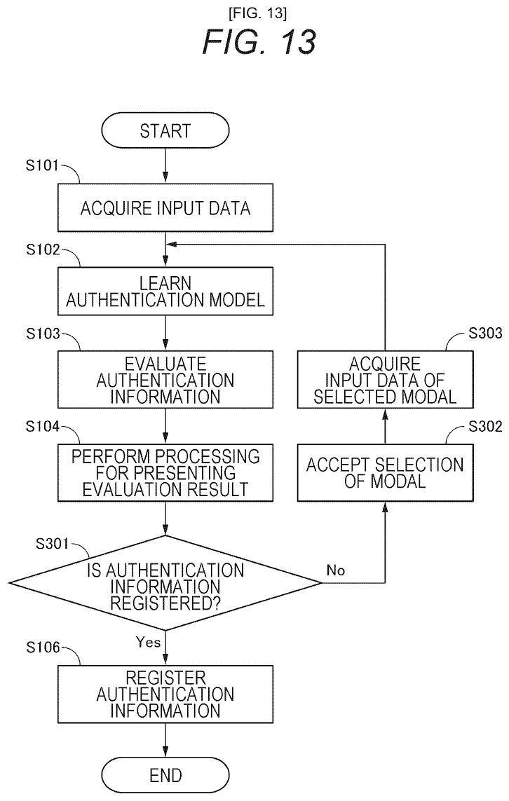

In the embodiment, it has been described that input data belonging to a predetermined modal is input to the information processing apparatus 200, but the present technology is not limited thereto, and the user may select a modal to be used for authentication. A first modification of the information processing apparatus 200 in a case where the user selects a modal will be described with reference to FIG. 13.

In a flowchart of FIG. 13, Steps S101 to S104 are similar to those of the embodiment.

In Step S301, it is determined whether or not the user agrees to the registration of the authentication information. In a case where the user does not agree to the registration of the authentication information, the processing proceeds to Step S302 (No in Step S301).

Next, in Step S302, selection of a modal to be used for authentication from the user is accepted. The user can select the modal after confirming the evaluation result regarding the presented authentication information. For example, a plurality of modal candidates may be presented on the display as the output unit 106, and the user may select a modal to be used for authentication from the candidates through the input unit 105.

Next, in Step S303, the information processing apparatus 200 acquires a plurality of input data belonging to one or a plurality of modalities selected by the user. In order to acquire the input data, a plurality of pieces of input data belonging to one or a plurality of selected modals may be presented to the user to prompt the user to input the input data.

Then, the processing of Steps S101 to S104 and Steps S301 to S303 is repeated until the authentication information is registered. Then, in a case where the user agrees to the registration of the authentication information by the user in Step S301, the authentication information is registered in Step S106, and the processing ends (Yes in Step S301).

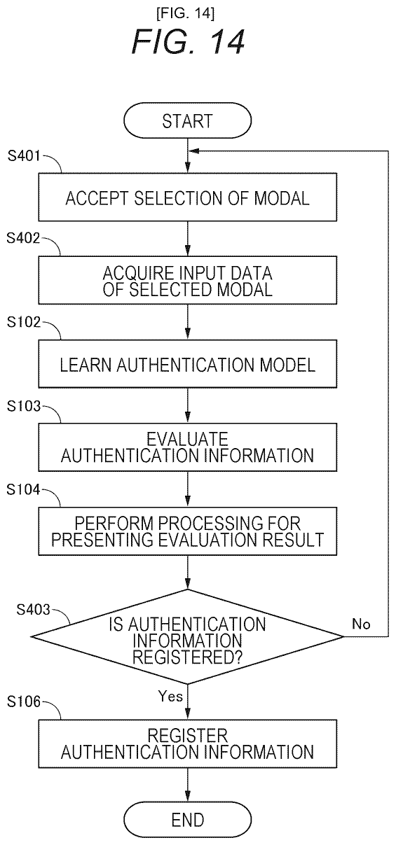

Further, the selection of the modal by the user may be performed before the acquisition of the input data. A second modification of the information processing apparatus 200 in which the user selects a modal to be used for authentication will be described with reference to FIG. 14.

First, in Step S401, selection of input data to be used for authentication from the user is accepted. Here, a plurality of modal candidates may be presented on the display as the output unit 106, and the user may select one or a plurality of modalities desired to be used for authentication from the candidates through the input unit 105.

Next, in Step S402, the information processing apparatus 200 acquires a plurality of pieces of input data belonging to the modal selected by the user. In order to acquire the input data, a plurality of pieces of input data belonging to one or a plurality of selected modals may be presented to the user to prompt the user to input the input data.

Steps S102 to S104 are similar to those in the embodiment.

Then, in Step S403, in a case where the user does not agree to the registration of the authentication information, the processing proceeds to Step S401 (No in Step S403).

Then, in Step S401, the selection of the modal is received from the user again.

Then, the processing of Steps S401 to S403 and Steps S102 to S104 is repeated until the authentication information is registered. Then, in a case where the user agrees to the registration of the authentication information in Step S403, the authentication information is registered in Step S106, and the processing ends (Yes in Step S403).

Note that each step may be performed simultaneously on the UI.

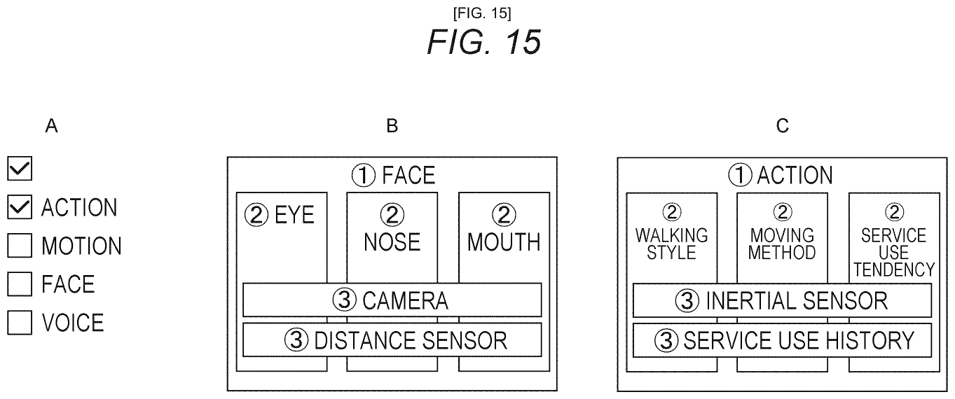

Here, a UI for the user to select a modal will be described. As the UI, a general UI for selecting an item as illustrated in FIG. 15A may be adopted.

Furthermore, as illustrated in FIGS. 15B and 15C, a UI that visually represents a modal relationship may be adopted. FIGS. 15B and 15C illustrate sensors that can acquire input data on a modal and a submodal included in the modal, modal, and input data on the modal and the submodal. Specifically, in FIG. 15B, the modal “face” includes submodal “eyes”, “nose”, and “mouth”, and it is visually indicated that input data of each modal can be acquired by a camera and a distance sensor. In FIG. 15C, the modal “action” includes “walking style”, “moving method”, and “service use tendency” which are submodal, and it is visually indicated that input data of each modal can be acquired by an inertial sensor and a service use history.

When the user is caused to select a modal, a plurality of candidates for setting for selecting authentication information may be presented to the user so that the user can compare them.

The information processing apparatus 200 may automatically select a modal so as to meet the requirements of the evaluation viewpoints of security, privacy, and usability. For example, the user selects an important evaluation viewpoint from among security, privacy, and usability, and then the information processing apparatus 200 may automatically select a modal.

Furthermore, the user may input a degree to which importance is placed on each evaluation viewpoint, and the information processing apparatus 200 may automatically select a modal on the basis of the degree. For example, the degree can be input as a numerical value (such as a continuous numerical value from 0 to 100) or can be input in discrete steps (such as “strong, medium, and weak”). Note that, in a case where there is no modal corresponding to the degree input by the user, output corresponding to “not applicable” may be performed.

In a case where the user can select a modal, the information processing apparatus 200 may recommend the modal instead of the user directly selecting the modal one by one. This is because if the degree of freedom of modal selection is too high, it may be a burden on the user.

Furthermore, in Step S101 of the flowcharts illustrated in FIGS. 3 and 13, input data of a modal determined in advance by an authentication service provider, a system designer, or the like is acquired, but input data of a modal recommended by the information processing apparatus 200 may be acquired.

The modal to be recommended may be determined according to the user from three evaluation viewpoints, or may be a combination generally known in each modal.

A modal that emphasizes each of three evaluation viewpoints, such as recommendation that emphasizes security, recommendation that emphasizes privacy, and recommendation that emphasizes usability, may be recommended. Furthermore, a modal that emphasizes the balance of the three evaluation viewpoints may be recommended.

The user may select which one of security, privacy, and usability is prioritized, and present a corresponding modal to the user so that the user determines the modal.

The modal to recommend can be determined by selecting a modal that is generally considered relevant for each evaluation viewpoint. Furthermore, it is also possible to prevent a modal considered not to be generally related to each evaluation viewpoint from being included in a modal to be recommended.

For example, in a case where security is emphasized, a face or a fingerprint is set as a candidate to be recommended, and a motion is excluded from candidates to be recommended. In addition, in the case of emphasizing privacy, an action or a motion is set as a candidate to be recommended, and a position and a face are excluded from the candidates to be recommended. In addition, in a case where usability is emphasized, a position and an object are set as candidates to be recommended and a motion and a password are excluded from the candidates to be recommended. Furthermore, in the case of emphasis on balance, a face and a fingerprint are candidates to be recommended.

In addition, an index may be determined as an evaluation function in accordance with an important evaluation viewpoint, and a parameter space of a way of combining modalities may be optimized. For example, a parameter space is set to 1 in a case where a modal is selected, and is set to 0 in a case where no modal is selected. In a case where security is emphasized, a modal is selected by applying a general optimization method with an index “authentication level” as an evaluation function.

The number of modalities to be recommended is not limited to one and may be plural. Furthermore, the user can confirm the recommendation result and select the modal again. The modal is recommended so that the time and effort can be reduced when the user customizes and the load on the user can be reduced.

Note that the information processing apparatus 200 may include a recommendation processing unit that performs processing related to recommendation, or the control unit 102 of the electronic device 100 may perform processing related to recommendation.

### [2-2. Other Modifications]

Other modifications of the present technology will be described.

The authentication information may be updated to improve the performance of the authentication function after registration. The update of the authentication information can be performed by processing similar to the registration of the authentication information. At that time, any step may be omitted. For example, the step of presenting the authentication information to the user for confirmation is omitted, the step of reselecting the modal is omitted, or the like. This is because it is troublesome for the user to request the user for confirmation every time, and the usability is deteriorated.

The registered authentication information may be updated by adding new data to the input data used at the time of registration and recalculating. In addition, the registered authentication information may be updated by a general method of relearning by adding new data to the input data used at the time of registration. In a case where the authentication information is updated, the user may be notified of the update by a general notification method such as display on a display or voice output.

The update of the authentication information may be performed in response to an instruction input from the user, or may be automatically determined by the information processing apparatus 200. In a case where the information processing apparatus 200 automatically performs update, the user may be notified of the update by a general notification method such as display on a display or audio output.

The authentication information can be updated at any timing. In addition, the number of times of update may be determined in advance, and the update may be performed at a predetermined timing (every day, every week, every month, etc.) until the determined number of times of update is performed. In addition, the update may be periodically performed, for example, every night, every month, every day for one week after registration, and every month thereafter.

In addition, the update may be performed under a specific condition. For example, the update may be performed in a case where the authentication level of the determination result is weak (equal to or less than a predetermined threshold). In addition, in the authentication at the time of using various services requesting the authentication, the update may be performed using the data up to that time point at the timing when the person is determined to be the person himself/herself. For example, in a case where the position of the user is away from the normal range of action by a predetermined distance on the basis of the position information, the update is performed every hour.

Furthermore, in order to switch according to the situation, a plurality of different authentication models may be learned and registered. In addition, the authentication model may also be updated in accordance with the update of the authentication information.

In addition, a step of performing identity confirmation of the user before registration of the authentication information may be included. For example, the identity of the user can be confirmed by reading an integrated circuit (IC) chip of My Number Card and using a public personal authentication service.

Furthermore, the registered authentication information may be transferred to another device different from the electronic device 100. For example, in a case where the electronic device 100 is a smartphone, the authentication information may be taken over in a case where the model of the smartphone is changed, or the authentication information may be made available in a function in another device.

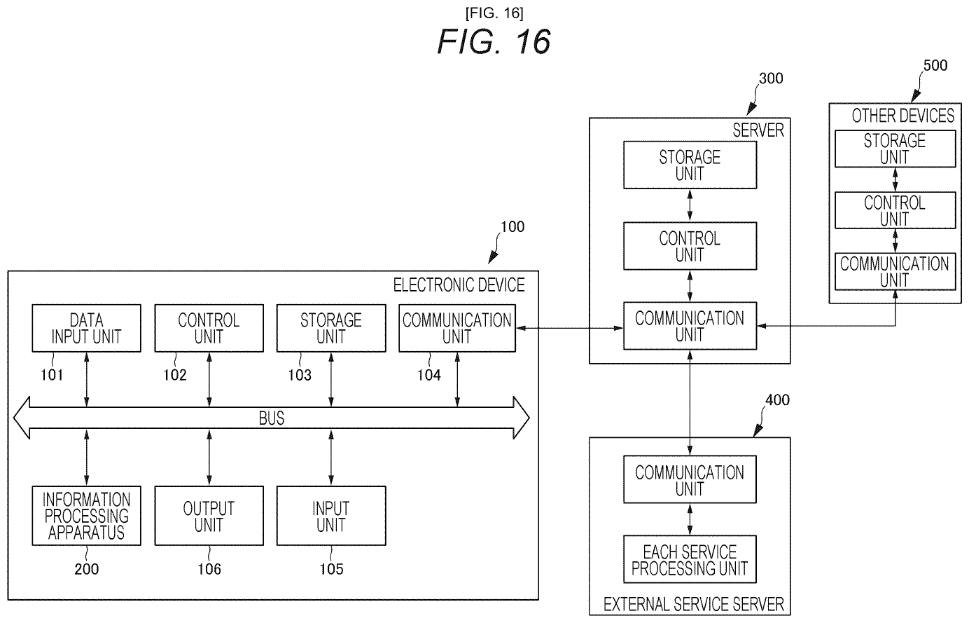

As illustrated in FIG. 16, the electronic device 100 may be connected to an external server 300, a service server 400 that requests authentication in providing a service, another device 500, or the like.

The information processing apparatus 200 may acquire input data from the server 300, the service server 400, another device 500, or the like.

Furthermore, the server 300 may have a function as the information processing apparatus 200, and the processing according to the present technology may be performed in the server apparatus 300. In this case, the electronic device 100 transmits the input data to the server 300 through the communication unit 104. In addition, the electronic device 100 receives the authentication result output from the server 300 through the communication unit 104 and outputs the authentication result in the output unit 106.

The present technology can also have the following configurations.

(1)

An information processing apparatus including:
an evaluation unit that evaluates a plurality of pieces of authentication information regarding a user on a basis of a plurality of evaluation viewpoints and an index for each of the evaluation viewpoints; and
a presentation processing unit that performs processing for presenting an evaluation result by the evaluation unit to the user.
   (2)

The information processing apparatus according to (1), in which the evaluation viewpoint is security.

(3)

The information processing apparatus according to (1) or (2), in which the evaluation viewpoint is privacy.

(4)

The information processing apparatus according to (2) any one of (1) to (3), in which the evaluation viewpoint is usability.

(5)

The information processing apparatus according to (2), in which the index for the security includes authentication strength and resistance to an attack from another person.

(6)

The information processing apparatus according to (3), in which the index for the privacy is description of necessity of a modal and input data to be used.

(7)

The information processing apparatus according to (4), in which the index for the usability includes an error rate, stability, and cost.

(8)

The information processing apparatus according to any one of (1) to (7), in which the evaluation unit evaluates the authentication information on a basis of any one or more of the plurality of evaluation viewpoints.

(9)

The information processing apparatus according to any one of (1) to (8), in which the evaluation unit evaluates the authentication information on a basis of any one or a plurality of the evaluation viewpoints.

(10)

The information processing apparatus according to any one of (1) to (9), in which the presentation processing unit converts the evaluation result into information for a predetermined presentation method.

(11)

The information processing apparatus according to any one of (1) to (10), further including a registration unit configured to register the authentication information on the basis of an agreement of the user who has confirmed the evaluation result processed and presented by the presentation processing unit.

(12)

The information processing apparatus according to any one of (1) to (11), in which the authentication information is classified into any of a plurality of types of information defined as a modal.

(13)

The information processing apparatus according to (12), in which the modal is selected by the user.

(14)

The information processing apparatus according to (13), in which the modal is selected by the user who has confirmed the evaluation result regarding the presented predetermined authentication information.

(15)

The information processing apparatus according to (11), in which the registration unit learns an authentication model on a basis of the authentication information.

(16)

An information processing method
performing processing for evaluating a plurality of pieces of authentication information regarding a user on a basis of a plurality of viewpoints and an index for each of the viewpoints, and presenting an evaluation result to the user.
   (17)

A program for causing a computer to execute an information processing method
performing processing for evaluating a plurality of pieces of authentication information regarding a user on a basis of a plurality of viewpoints and an index for each of the viewpoints, and presenting an evaluation result to the user.

### REFERENCE SIGNS LIST

200 Information processing apparatus
201 Evaluation unit
202 Registration unit
203 Presentation processing unit

1. An information processing apparatus comprising:
an evaluation unit that evaluates a plurality of pieces of authentication information regarding a user on a basis of a plurality of evaluation viewpoints and an index for each of the evaluation viewpoints; and
a presentation processing unit that performs processing for presenting an evaluation result by the evaluation unit to the user.

2. The information processing apparatus according to claim 1, wherein
the evaluation viewpoint is security.

3. The information processing apparatus according to claim 1, wherein
the evaluation viewpoint is privacy.

4. The information processing apparatus according to claim 1, wherein
the evaluation viewpoint is usability.

5. The information processing apparatus according to claim 2, wherein
the index for the security includes authentication strength and resistance to an attack from another person.

6. The information processing apparatus according to claim 3, wherein
the index for privacy is a need for a modal and a description of input data to be utilized.

7. The information processing apparatus according to claim 4, wherein
the index for the usability includes an error rate, stability, and cost.

8. The information processing apparatus according to claim 1, wherein
the evaluation unit evaluates the authentication information on a basis of any one or more of the plurality of evaluation viewpoints.

9. The information processing apparatus according to claim 1, wherein
the evaluation unit evaluates the authentication information on a basis of one or a plurality of indexes in the evaluation viewpoint.

10. The information processing apparatus according to claim 1, wherein
the presentation processing unit converts the evaluation result into information for a predetermined presentation method.

11. The information processing apparatus according to claim 1, further comprising
a registration unit that registers the authentication information on a basis of an agreement of the user who has confirmed the evaluation result processed and presented by the presentation processing unit.

12. The information processing apparatus according to claim 1, wherein
the authentication information is classified into any of a plurality of types of information defined as a modal.

13. The information processing apparatus according to claim 12, wherein
the modal is selected by the user.

14. The information processing apparatus according to claim 13, wherein
the modal is selected by the user who has confirmed the evaluation result regarding the presented predetermined authentication information.

15. The information processing apparatus according to claim 11, wherein
the registration unit learns an authentication model on a basis of the authentication information.

16. An information processing method
performing processing for evaluating a plurality of pieces of authentication information regarding a user on a basis of a plurality of viewpoints and an index for each of the viewpoints, and presenting an evaluation result to the user.

17. A program for causing a computer to execute an information processing method
performing processing for evaluating a plurality of pieces of authentication information regarding a user on a basis of a plurality of viewpoints and an index for each of the viewpoints, and presenting an evaluation result to the user.
